(19) United States
(12) Patent Application Publication
(10) Pub. No.: US 2014/0141298 A1
(43) Pub. Date: May 22, 2014

(54) RECHARGEABLE ELECTRIC BATTERY

(71) Applicant: Martin Michelitsch, Kumberg (AT)

(72) Inventor: Martin Michelitsch, Kumberg (AT)

(73) Assignee: AVL LIST GMBH, Graz (AT)

(21) Appl. No.: 14/129,984

(22) PCT Filed: Jun. 22, 2012
(86) PCT No.: PCT/EP2012/062054

§ 371 Date: Jan. 27, 2014

(30) Foreign Application Priority Data
Jun. 30, 2011 (AT) A 959/2011

(51) Int. Cl. H01M 10/6563

(52) U.S. Cl. CPC H01M 10/5067
USPC 429/71

(57) ABSTRACT

A rechargeable electric or high-voltage battery for an electric vehicle, with at least two stacks of battery cells arranged side-by-side in a line in the direction of stacking The stacks are arranged side-by-side in a housing, with cooling air flowing through cooling air channels arranged within the housing transversely to the direction of stacking. The cooling air channels form a closed cooling air circuit for cooling the battery, with the cooling air circuit having at least one cooling air fan and at least one heat exchanger.

### CROSS-REFERENCE TO RELATED APPLICATIONS

The present application is a National Stage Application of PCT International Application No. PCT/EP2012/062054 (filed on Jun. 22, 2012), under 35 U.S.C. §371, which claims priority to Austrian Patent Application No. A 959/2011 (filed on Jun. 30, 2011), which are each hereby incorporated by reference in their respective entireties.

### TECHNICAL FIELD

Embodiments relate to a rechargeable electric battery, in particular, a high-voltage battery, preferably for an electric vehicle, with at least two stacks of battery cells arranged side-by-side in a line in the direction of stacking, with the stacks arranged side-by-side in a housing, with cooling air able to flow through cooling air channels arranged within the housing transversely to the direction of stacking, with the cooling air channels being part of a closed cooling air circuit for cooling the battery, preferably with the cooling air circuit having at least one cooling air fan and at least one heat exchanger.

### BACKGROUND

High-voltage batteries, particularly employing lithium-ion battery cells, can only be operated within strictly defined temperature ranges. The high voltage batteries are usually brought to the right temperature by way of a closed cooling air circuit or by way of an open cooling air system.

WO 2010/053689 A2 describes a battery arrangement with a housing and a plurality of lithium-ion cells arranged side-by-side. A thermally conductive, electrically insulating fluid flows through the housing for cooling purposes. While liquid-cooled systems permit high cooling performance, they have many sealed points and thus bear a high risk of leakage. Leaking coolant can result in short circuits inside or outside the battery.

WO 2010/067944 A1 discloses a battery with stacks of battery cells arranged side-by-side, with battery cells being cooled by cooling air. Air-cooled batteries are usually cooled in an open cooling air circuit. Cooling air is drawn from the surrounding area and guided around the battery and/or through cooling air channels inside the battery, dissipating heat from the battery. The heated cooling air is conveyed back into the surrounding area. However, temperature variations, moisture variations, air pollution or the like can have a negative effect on cooling performance and the service life of the battery.

WO 2011/067490 A1 discloses a cooling apparatus for a vehicle battery where the cooling air is guided over the battery cells in a closed circuit by way of a fan. The cooling air is then conveyed to the front side of the battery and cooled again by a heat exchanger.

U.S. Patent Publication No. 2010 236 846 A1 and European Patent Publication EP 2 133 952 A1 respectively disclose cooling devices for vehicle batteries, with the cooling air being guided in a closed circuit. The cooling devices contain at least one cooling air fan and one heat exchanger.

### SUMMARY

The object of embodiments is to avoid the given disadvantages and facilitate efficient cooling of the battery in the simplest manner possible that is largely independent of environmental influences.

In accordance with embodiments, this is achieved by at least one battery cell being encapsulated by one plastic cell casing, with the plastic cell casing having a protruding sealing seam, preferably in the area of a cell middle plane, arranged to run along the narrow side of the battery cell, with a space defined between each of the seal seams of the adjacent battery cells of a stack.

Provision is made in a particularly compact embodiment of the invention for the cooling air fan and/or the heat exchanger to be arranged within the housing. This space can form a first and/or second cooling air channel.

In this context, at least one first cooling air channel can be arranged in the direction of a vertical axis of the battery and at least a second cooling air channel in the direction of a transverse axis of the battery that is developed at a right angle to the vertical axis and to the stacking direction.

The closed cooling air circuit allows for the battery to be cooled largely free of disadvantageous environmental influences such as fluctuations in temperature and moisture, air pollution, or similar. This ensures constant optimal operating conditions for the battery and facilitates a long service life for it.

The air flows through and cools the region between the two adjacent stacks via the first cooling air channel. The second cooling air channels conducting the flow of cooling air are arranged on the upper side of the battery and serve to cool the cell terminals and/or the electrical cell connectors. The latter can be cooled particularly well when at least one cell connector, preferably having a U-shaped or Y-shaped profile or cross-section for electrically connecting two adjacent battery cells, projects into a second cooling air channel.

At least one sealing seam of a battery cell of a first stack can project into a space defined by the sealing seams of two adjacent battery cells of a second stack. The seal seams bordering the space or projecting into the space create guide surfaces for the cooling air flow. In this manner on the one hand the conveyance of cooling air is improved and on the other, the surface touched by the cooling area is enlarged.

The measures described can increase the cooling capacity and/or reduce the requisite installation space, with an advantageous impact on the volumetric energy density as well.

### DRAWINGS

Embodiments will be explained below by reference to the drawings, wherein:

FIG. 1 illustrates a battery in accordance with embodiments in an oblique view from above.

FIG. 2 illustrates the battery in cross-section corresponding to the line II-II in FIG. 1.

FIG. 3 illustrates the battery in a frontal view.

FIG. 4 illustrates the battery in an oblique view from below.

FIG. 4a illustrates the battery in cross-section corresponding to line IVa-IVa in FIG. 4.

FIG. 4b illustrates the battery plus housing in one embodiment, in cross-section similar to FIG. 4a.

FIG. 5 illustrates a battery module of the battery in an oblique view.

FIG. 6 illustrates this battery module in an oblique view from below.

FIG. 7 illustrates a stack of battery cells in an oblique view.

FIG. 8 illustrates this stack in a side view.

FIG. 9 illustrates the stack of battery cells of a battery module in an oblique view.

FIG. 10 illustrates a battery module in cross-section corresponding to line X-X in FIG. 9.

FIG. 11 illustrates a detail of this battery module in cross-section similar to FIG. 10.

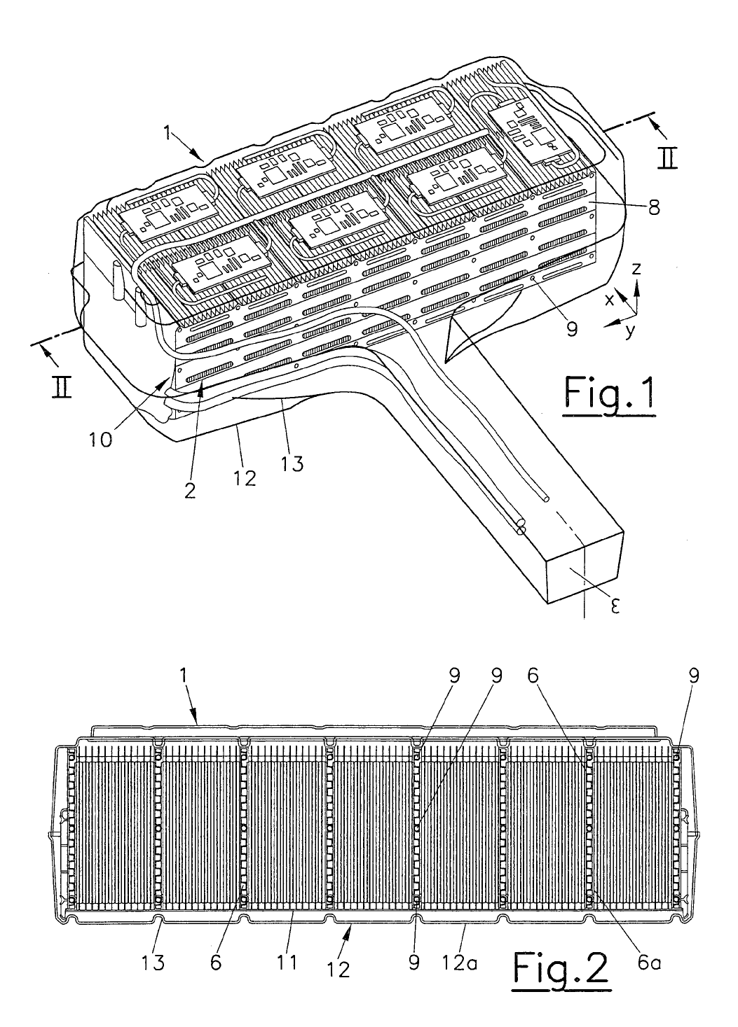

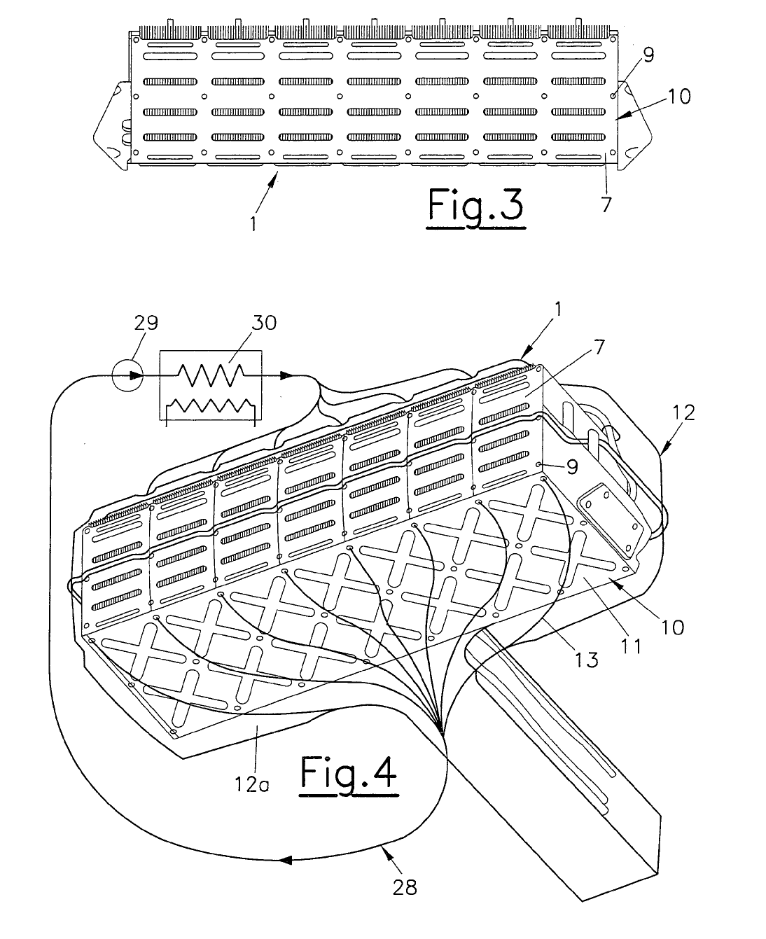

### DESCRIPTION

The rechargeable battery 1 in the accordance with embodiments is provided with seven battery modules 2, with each battery module 2 having two stacks 3, 4 of fastened battery cells 5 arranged side-by-side. The stacks 3, 4 of each battery module 2 are arranged between two structurally stiff corrugated plates 6 made of, for example aluminium, or plastic, where the plates 6 can be developed from die cast parts. The plates 6 themselves are fixed between two retaining plates 7, 8 on the front and rear sides of the battery 1, with the retaining plate 7 on the front side being firmly connected to the retaining plate 8 on the rear side by way of locking screws 9. The locking screws 9 are arranged in the region of the plates 6. Together with the retaining plates 7, 8, the plates 6 form a holding frame 10 for the battery modules 2. The retaining plates 7, 8 are provided with openings in order to keep the weight as minimal as possible. The gap, viewed in stacking direction y, defined between the locking screws 9 ensures that the battery cells 5 are installed in the correct position and with a specified pretensioned force that is essentially constant for the service life of the battery 1. An elastic insulation layer 6a, made for example from a foam, is arranged between each of the plates 6 and the adjacent battery cells 5, allowing for the pressure to be distributed evenly and gently. The battery 1 is sealed from below by the bottom plate 11.

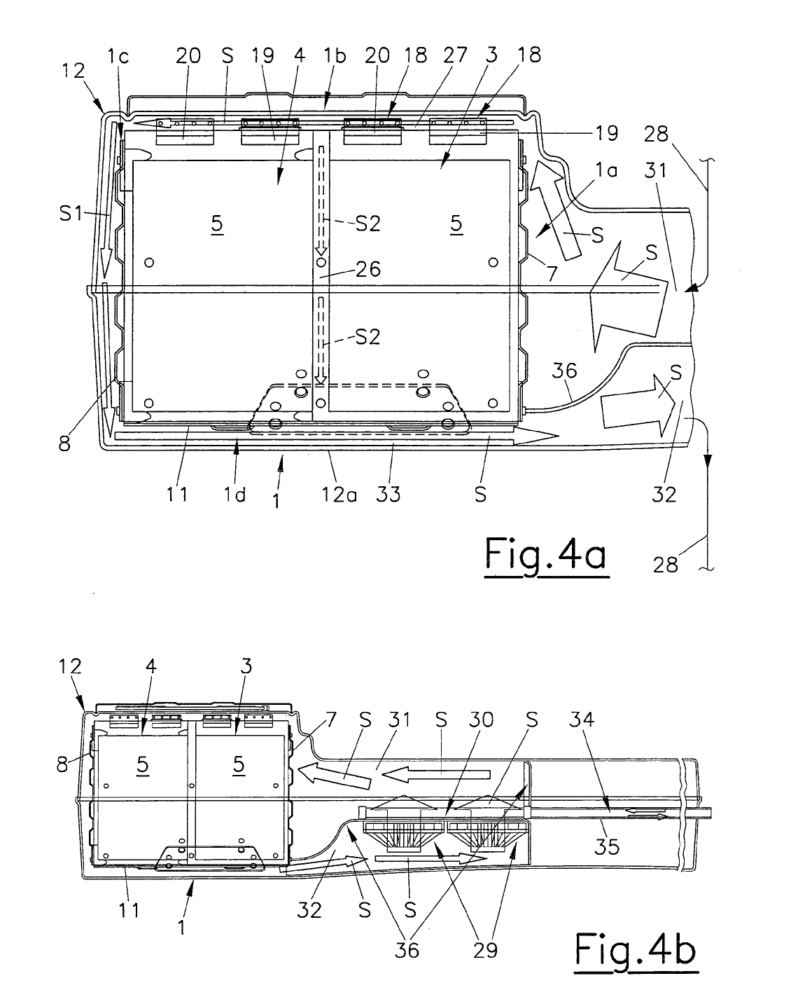

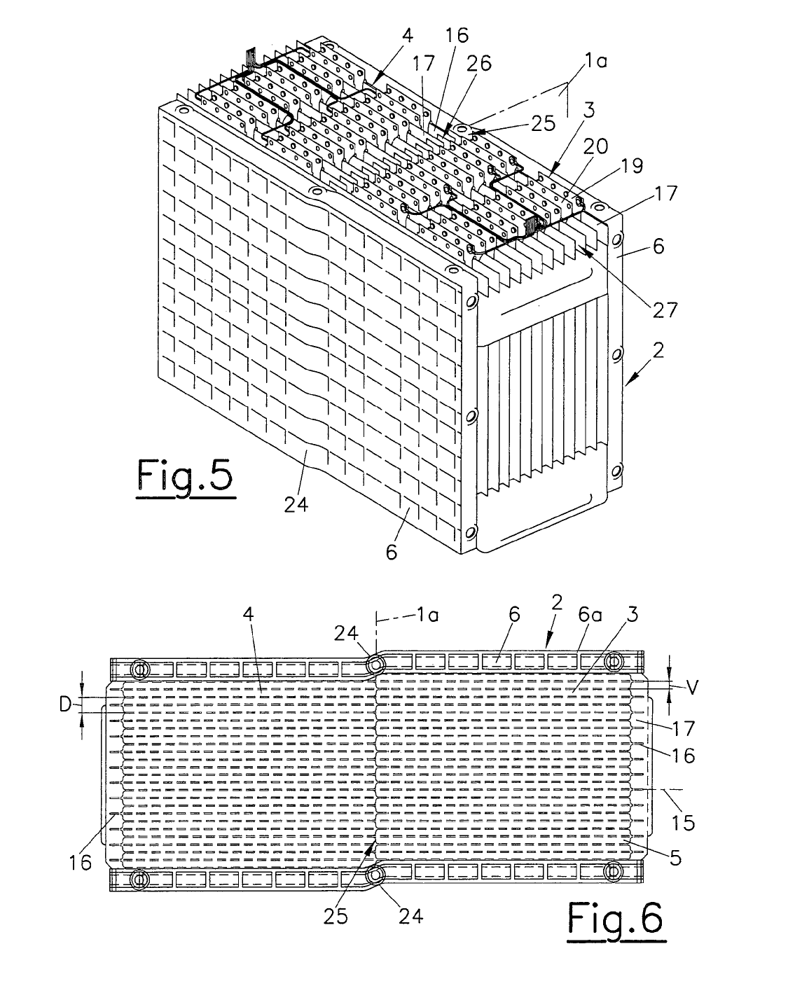

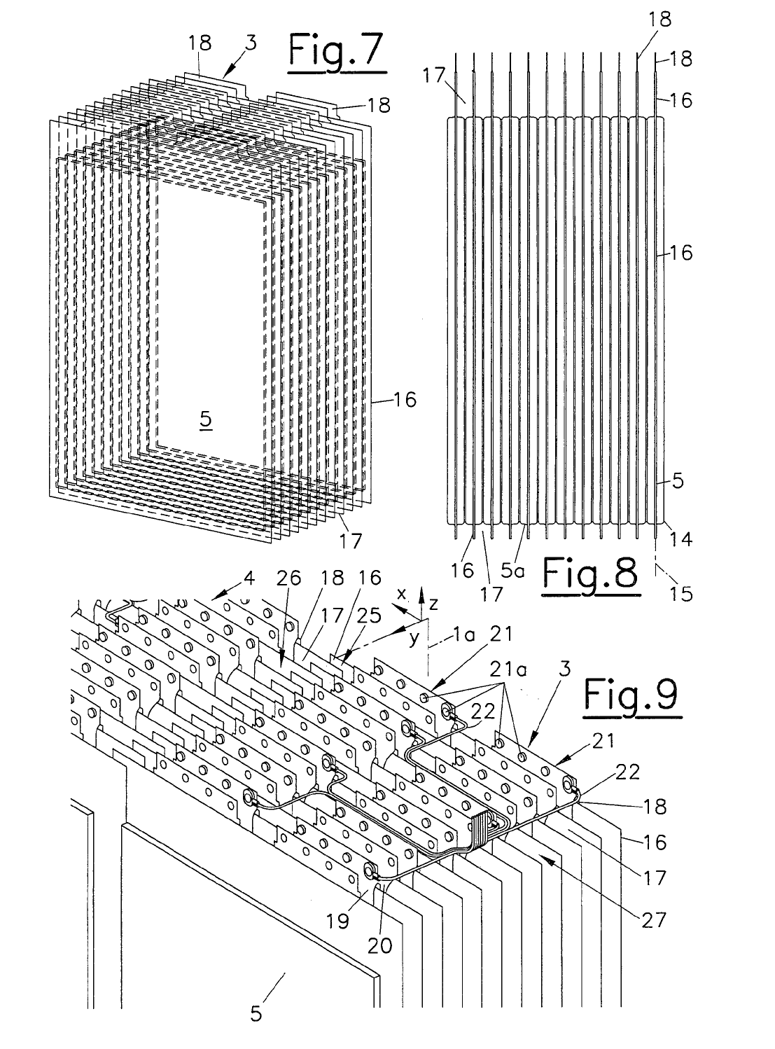

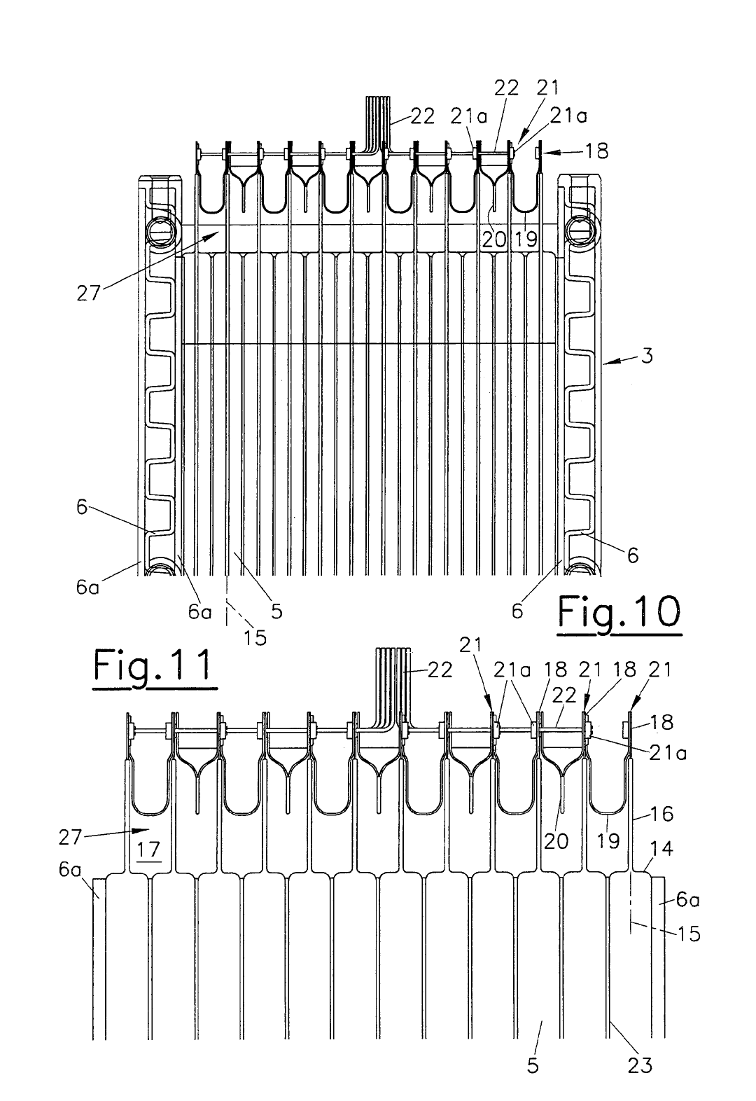

The battery 1 including the mounting frame 10 is arranged in a housing 12, with cooling air flow paths developed between the housing 12 and the battery 1. In order to guide the flow of cooling air, flow guide surfaces 13 are integrated into the housing floor 12a, as illustrated in FIGS. 2 and 4.

Each battery cell 5 is encapsulated by a plastic casing 14, with the plastic casing 14 having a protruding sealing seam 16 along the narrow side 5a for sealing purposes roughly in the area of a cell middle plane 15. A space 17 is defined between the sealing seams 16 of adjacent battery cells 5 of a stack 3, 4 in each case.

In order to save installation space, the two stacks 3, 4 of each battery module 2, which are arranged side-by-side, are developed to overlap and be offset in relation to each other. The offset V is about half the thickness D of a battery cell 5. The sealing seams 16 of a battery cell 5 of the one stack 3, 4 project into a space 17 defined by the sealing seams 16 of two adjacent battery cells 5 of the other stack 4, 3. In this manner the space 17 can be used at least partially by accommodating a part of the sealing seam 16. This has a very advantageous effect on the constructed space and volumetric energy density. The offset V between the two stacks 3, 4 means that the plates 6 develop a step 24 in the area of a longitudinal middle plane 1a of the battery 1.

Cell terminals 18, connected to each other via U-shaped and Y-shaped cell connectors 19, 20, project from the plastic casings 14 on the upper narrow side 5a. The connection between the cell connectors 19, 20 and the cell terminals 18 can be developed as a clinch connection 21 provided with one or a plurality of clinch points 21a in a clinching process. This facilitates a particularly high current carrying capability as a result of multiple connecting points as well as a long-term anti-corrosion connection owing to the airtight encapsulated connection points and simple contacting of the cell terminals 18 with different materials (copper to aluminium and vice versa), without additional structural elements. Two to four sheets can be connected to each other electrically with the same tool by way of clinching, with the materials copper, aluminium and steel being particularly suitable with wall thicknesses from 0.1 mm to 0.5 mm. Consequently, if required, cell voltage monitoring cables 22 can be connected to the cell terminals 18 with the cell connectors 19, 20 at the same time in a further operation in a clinching process. As the position of the clinch points 21a of the clinch connection 21 is allowed to vary more than for example is the case for a laser welded connection, a relatively large tolerance compensation capability results. The use of parallel and multipurpose tools allows simpler and cost-effective production for larger production runs, with only a few easily controllable input variables such as material wall thicknesses, press force etc. involved. The clinch points 21a protruding into the cooling air channel 27 increase the heat dissipating surface area of the battery 1, a fact of particular significance in the case of direct air cooling of the cell terminals 18. The projecting clinch points 21 a also contribute to increasing turbulence, something that improves heat transfer, particularly in the case of air cooling. Consequently, the positive effect of the clinch points 21 a on the cooling also contributes to the increase in the volumetric energy density as a result of efficient utilisation of installation space.

In order to achieve an especially good volumetric energy density, it is necessary to position the battery cells 5 as close to each other as possible. In addition, a thermal and electrical insulating layer 23, for example an insulation foil, that is as thin as possible is arranged between the battery cells 5 in order to prevent the occurrence of a “domino effect” in the event of thermal overloading of an adjacent battery cell 5.

At the same time, the spaces 17 create the cooling air channels 26, 27. The spaces 17 form first cooling air channels 26 in the region of the overlap 25 of the two stacks 3,4, i.e., in the region of the longitudinal middle plane la of the battery 1, with said channels arranged in the direction of the vertical axis z of the battery 1. The sealing seams 16 form flow guide surfaces for the stream of air and the heat dissipating surfaces. Second cooling air channels 27 are formed in the region of the cell terminals 18 by the spaces 17 on the upper side of the battery cells 5 in the direction of a transverse axis x at a right angle to the vertical axis z and to the direction of stacking y.

The first and second cooling air channels 26, 27 are part of a closed cooling air circuit 28 for cooling the battery 1, with the cooling air circuit 28 having at least one cooling air fan 29 and at least one heat exchanger 30.

In the embodiment illustrated schematically in FIG. 4a, the housing 12 is provided with a cooling air inflow path 31 and a cooling air outflow path 32, with a cooling air inflow path 31 and a cooling air outflow path 32 arranged here in the area of the same first longitudinal side 1a (front side) of the battery 1. The cooling air, coming from the cooling air fan 29 and the heat exchanger 30, is conveyed into the housing 12 via the cooling air inflow path 31 corresponding to the arrow S in FIG. 4a via the second cooling air channels 27 in the region of the cell terminals 18 of the battery cells 5 in the region of the upper side 1b of the battery 1 to a second longitudinal side 1c (rear side) of the battery, facing away from the first longitudinal side 1a. A portion S1 of the air flows between the second longitudinal side 1c of the battery 1 and the housing 12 to an underside 1d of the battery 1 and flows back to the first longitudinal side 1a of the battery 1 in the area of the underside 1d in a main collector 33 formed between the base plate 11 of the battery 1 and the housing 12 and on to the cooling air outflow path 32. A further portion S2 of the cooling air flows through the first cooling air channels 26 between the two stacks 3, 4 from the battery cells 5 to the underside ld of the battery 1 and also reaches the main collector 33.

The cooling air therefore flows through the second cooling air channels 27, cooling the cell terminals 18 and the cell connectors 19, 20. After this a portion of the cooling air reaches the first cooling air channels 26, which guide the cooling air downward in the direction of the vertical axis z. Air flows through all cavities and spaces 17 of the battery 1 and the accumulated heat is extracted. The remaining cooling air flows between the retaining plate 7 on the first longitudinal side 1a (front side) of the battery 1 and the housing 12 to the housing floor 12a of the housing 12, where it is guided by the flow guide surfaces 13 to the vehicle's longitudinal middle plane 8 and collected. The cooling air then leaves the housing 12 through the cooling air outflow path 32 and is drawn in again by the cooling air fan 29 and cooled in the heat exchanger 30, before it is fed into the closed cooling circuit 28 of the battery 1 again.

As illustrated in FIG. 4b, the cooling air fan 29 and heat exchanger 30 can also be arranged within the housing 12 of the battery 1, with said housing sealed hermetically. In the embodiment illustrated the cooling air fan is provided with two blowers arranged upstream from the heat exchanger 30. The heat exchanger 30 is developed as an air/water heat exchanger, with cooling water supply and drainage lines 34, 35 connected to the heat exchanger 30. Flow guide surfaces for the cooling air S are indicated by the reference symbol 36.

What is claimed is:

1. Rechargeable electric battery (1), in particular a high-voltage battery, preferably for an electric vehicle, with at least two stacks (3, 4) of battery cells (5) arranged side-by-side in a line in the direction of stacking (y), with the stacks (3, 4) arranged side-by-side in a housing (12), with cooling air able to flow through cooling air channels (26, 27) arranged transversely to the direction of stacking within the housing (12), with the cooling air channels (26, 27) being part of a closed cooling air circuit (28) for cooling the battery (1), preferably with the cooling air circuit (28) having at least one cooling air fan (29) and at least one heat exchanger (30), characterized in that at least one battery cell (5) is encapsulated by a plastic cell casing (14), with the plastic cell casing (14) having a protruding sealing seam (16)—preferably in the area of a cell middle plane (15)—arranged to run along the narrow side (5a) of the battery cell (5), with a space (17) defined between each of the seal seams (16) of the adjacent battery cells (5) of a stack (3, 4).

2. Battery (1) according to claim 1, characterized in that at least a first cooling air channel (26) is arranged in the direction of a vertical axis (z) of the battery (1) and at least a second cooling air channel (27) is arranged in the direction of a transverse axis (x) of the battery (1) developed at a right angle to the vertical axis (z) and at a right angle to the direction of stacking (y).

3. Battery (1) according to either claim 1 or 2, characterized in that the space (17) develops the first and/or second cooling air channel (25, 26).

4. Battery (1) according to any one of claims 1 to 3, characterized in that at least one sealing seam (16) of a battery cell (5) of the one stack (3, 4) projects into a space (17) defined by the sealing seams (16) of two adjacent battery cells (5) of the other stack (4, 3).

5. Battery (1) according to any one of claims 1 to 4, characterized in that the seal seams (16) bordering the space (17) or projecting into the space (17) create guide surfaces for the cooling air flow.

6. Battery (1) according to any one of claims 1 to 5, characterized in that at least one cell connector (19, 20)—preferably having a U profile or Y profile—for electrically connecting two adjacent battery cells (5) projects into a second cooling air channel (27).

7. Battery (1) according to any one of claims 1 to 6, characterized in that the housing (12) is provided with at least one cooling air inflow path (31) and at least one cooling air outflow path (32), preferably with a cooling air inflow path (31) and a cooling air outflow path (32) arranged in the area of the same first longitudinal side (la) of the battery (1).

8. Battery (1) according to any one of claims 1 to 7, characterized in that the cooling air coming from the cooling air inflow path (31) is conveyed via the second cooling air channels (27) in the region of the cell terminal (18) of the battery cells (5) in the region of the upper side of the battery (1) is conveyed at least partially to a second longitudinal side of the battery (1) facing away from the first longitudinal side, between the second longitudinal side of the battery (1) and the housing (12) to an underside of the battery (1) and to the underside of the battery (1) between a base plate (11) of the battery (1) and the housing (12) to the first longitudinal side (1a) of the battery (1) and on to the cooling air outflow path (32).

9. Battery (1) according to claim 8, characterized in that at least a portion of the cooling air is guided from the second cooling air channels (27) via the first cooling air channels (26) to the underside (1d) of the battery (1) and to the underside (1d) of the battery (1) between a base plate (11) of the battery (1) and the housing (12) to the first longitudinal side (1a) of the battery (1) and on to the cooling air outflow path (32).

10. Battery (1) according to either claim 8 or 9, characterized in that at least one main collector (33) is developed between the base plate (11) of the battery (1) and the housing (12), preferably with the main collector (33) having at least one flow guide surface (13) developed by way of a fin on the base plate (11) and/or on the housing (12) developed longitudinally to the flow.

11. Battery (1) according to any one of claims 1 to 10, characterized in that the cooling air fan (29) and/or the heat exchanger (30) are arranged within the housing (12).
